(19) United States
(12) Patent Application Publication
(10) Pub. No.: US 2026/0001565 A1
(43) Pub. Date: Jan. 1, 2026

(54) SYSTEM AND METHOD FOR VEHICLE SENSOR TIME SYNCHRONIZATION, AND FIELD PROGRAMMABLE GATE ARRAY CHIP

(71) Applicant: BEIJING BAIDU NETCOM SCIENCE TECHNOLOGY CO., LTD., Beijing (CN)

(72) Inventor: Taicheng ZHANG, Beijing (CN)

(73) Assignee: BEIJING BAIDU NETCOM SCIENCE TECHNOLOGY CO., LTD., Beijing (CN)

(21) Appl. No.: 19/318,178

(22) Filed: Sep. 3, 2025

(30) Foreign Application Priority Data
Dec. 10, 2024 (CN) 202411805640.X

(51) Int. Cl. B60W 50/00; B60W 60/00

(52) U.S. Cl. CPC B60W 50/0098; B60W 2050/0083; B60W 60/0015

(57) ABSTRACT

The present disclosure provides a system and a method for vehicle sensor time synchronization, and a field programmable gate array chip, in the field of artificial intelligence, such as sensor, artificial intelligence chip, and autonomous driving. The system for vehicle sensor time synchronization includes: target vehicle sensors and a field programmable gate array chip, the target vehicle sensors include all vehicle sensors in a target vehicle that require a timestamp information to be written; the target vehicle sensors are connected to the field programmable gate array chip, and are configured to send collected sensor data to the field programmable gate array chip; the field programmable gate array chip is configured to write the timestamp information into the sensor data based on a system time of the field programmable gate array chip; wherein the field programmable gate array chip comprises: a system module and a logic module; the system module and the logic module are respectively connected to at least one of the target vehicle sensors based on a principle of load balancing, and are respectively configured to write the timestamp information into obtained sensor data based on the system time.

The present application claims the priority of Chinese Patent Application No. 202411805640.X, filed on Dec. 10, 2024, with the title of “SYSTEM AND METHOD FOR VEHICLE SENSOR TIME SYNCHRONIZATION, AND FIELD PROGRAMMABLE GATE ARRAY CHIP”. The disclosure of the above application is incorporated herein by reference in its entirety.

### FIELD OF THE DISCLOSURE

The present disclosure relates to the technical field of artificial intelligence, and particularly to a system and a method for vehicle sensor time synchronization, and a field programmable gate array chip in the field of sensor, artificial intelligence chip, and autonomous driving.

### BACKGROUND OF THE DISCLOSURE

With the development of technology, autonomous vehicles have been increasingly and widely applied in different scenarios. Safe driving of an autonomous vehicle needs to rely on various vehicle sensors, which in turn involves the time synchronization of these sensors.

### SUMMARY OF THE DISCLOSURE

The present disclosure provides a system and a method for vehicle sensor time synchronization, and a field programmable gate array chip.

A system for vehicle sensor time synchronization, including:
target vehicle sensors and a field programmable gate array chip, the target vehicle sensors include all vehicle sensors in a target vehicle that require a timestamp information to be written;
the target vehicle sensors are connected to the field programmable gate array chip, and are configured to send collected sensor data to the field programmable gate array chip;
the field programmable gate array chip is configured to write the timestamp information into the sensor data based on a system time of the field programmable gate array chip;
wherein the field programmable gate array chip includes: a system module and a logic module;
the system module and the logic module are respectively connected to at least one of the target vehicle sensors based on a principle of load balancing, and are respectively configured to write the timestamp information into obtained sensor data based on the system time.

A field programmable gate array chip, including: a system module and a logic module;
the system module and the logic module are respectively connected to at least one of target vehicle sensors based on a principle of load balancing, and are configured to obtain sensor data collected by the connected target vehicle sensors, and write a timestamp information into the sensor data based on a system time in the field programmable gate array chip, wherein the target vehicle sensors include all vehicle sensors in a target vehicle that require a timestamp information to be written.

A method for vehicle sensor time synchronization, wherein the method is applied in a system module and a logic module, the method includes:
obtaining sensor data collected by connected target vehicle sensors;
writing a timestamp information into the sensor data based on a system time in a field programmable gate array chip;
wherein the system module and the logic module are both located in the field programmable gate array chip, and the system module and the logic module are respectively connected to at least one of the target vehicle sensors based on a principle of load balancing, the target vehicle sensors include all vehicle sensors in a target vehicle that require a timestamp information to be written.

A non-transitory computer readable storage medium with computer instructions stored thereon, wherein the computer instructions are used for causing a method for vehicle sensor time synchronization, wherein the method for vehicle sensor time synchronization includes:
obtaining sensor data collected by connected target vehicle sensors;
writing a timestamp information into the sensor data based on a system time into a field programmable gate array chip;
wherein the system module and the logic module are both located in the field programmable gate array chip, and the system module and the logic module are respectively connected to at least one of the target vehicle sensors based on a principle of load balancing, the target vehicle sensors include all vehicle sensors in a target vehicle that require a timestamp information to be written.

It should be understood that content described in this part is not intended to identify a key or important feature of an embodiment of the present disclosure, nor to limit the scope of the present disclosure. Other features of the present disclosure will become easy to understand through the following specification.

### BRIEF DESCRIPTION OF DRAWINGS

The drawings are used to better understand a solution and do not constitute a limitation of the present application. In the drawings:

FIG. 1 is a schematic diagram of the composition structure of a first embodiment of a system 100 for vehicle sensor time synchronization of the present disclosure;

FIG. 2 is a schematic diagram of the composition structure of a second embodiment of the system 200 for vehicle sensor time synchronization of the present disclosure;

FIG. 3 is a schematic diagram of the composition structure of a third embodiment of the system 300 for vehicle sensor time synchronization of the present disclosure;

FIG. 4 is a schematic diagram of the composition structure of a fourth embodiment of the system 400 for vehicle sensor time synchronization of the present disclosure;

FIG. 5 is a schematic diagram of the composition structure of an FPGA chip 102 of the present disclosure;

FIG. 6 is a flowchart of an embodiment of the method for vehicle sensor time synchronization of the present disclosure;

FIG. 7 shows a schematic block diagram of an electronic device 700 that can be used to implement an embodiment of the present disclosure.

### DETAILED DESCRIPTION OF PREFERRED EMBODIMENTS

Hereinafter, exemplary embodiments of the present disclosure will be described with reference to drawings, where various details of the embodiments of the present disclosure are included to facilitate understanding, and the various details should be considered as merely exemplary. Therefore, those skilled in the art should recognize that various changes and modifications can be made to the embodiments described herein without departing from a scope and a spirit of the present disclosure. Similarly, for clarity and conciseness, a description of a known function and a known structure is omitted in the following description.

In addition, it should be understood that a term “and/or” herein is merely an association relationship for describing associated objects, which means that three relationships can exist, for example, A and/or B can mean: A exists alone, A and B exist at the same time, and B exists alone. In addition, a character “/” herein generally indicates that front and rear associated objects are in an “or” relationship.

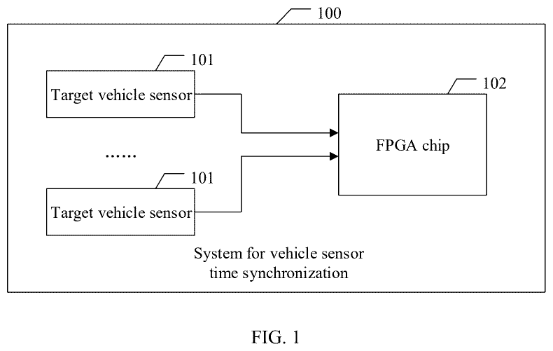

FIG. 1 is a schematic diagram of the composition structure of a first embodiment of a system 100 for vehicle sensor time synchronization of the present disclosure. As shown in FIG. 1, the system includes: target vehicle sensors 101 and a field programmable gate array (FPGA) chip 102.

The target vehicle sensors 101 include all vehicle sensors in a target vehicle that require a timestamp information to be written. Each target vehicle sensor 101 is connected to the FPGA chip 102, and is configured to send collected sensor data to the FPGA chip 102, and the FPGA chip 102 is configured to write the timestamp information in the sensor data based on a system time of the FPGA chip 102. The sensor data generally refers to sensor data collected in real time during a driving process of an autonomous vehicle.

The target vehicle sensor 101 can include a camera, a Radar, a light detection and ranging (Lidar), and an inertial measurement unit (IMU), etc. In addition, in an actual application, a vehicle sensor can further include a global positioning system (GPS), and the GPS has time information of the GPS.

In an existing manner, in order to realize time synchronization of a vehicle sensor, two chips are usually provided. The two chips can be a microcontroller unit (MCU) chip and a system on chip (SoC) chip. The camera, the Lidar, the IMU, and the GPS can be connected to the SoC chip. The Radar can be connected to the MCU chip. The timestamp of the camera, the Lidar, and the IMU is determined by a system time of the SoC chip. The GPS has time information of the GPS. The time information of the GPS can be utilized to correct the system time of the SoC chip. The timestamp of the Radar is determined by the system time of the MCU chip. The time synchronization between the SoC chip and the MCU chip can be performed through a precision time protocol (PTP), a generalized precision time protocol (gPTP), or other controller area network (CAN) protocol.

Compared to existing implementation manners, the system for vehicle sensor time synchronization 100 described in the present disclosure is converted from a multi-chip solution to a single-chip solution, thereby reducing the implementation cost, saving the system overhead, and so on.

The single chip can be the FPGA chip 102, and each target vehicle sensor 101 can be connected to the FPGA chip 102. For each target vehicle sensor 101, collected sensor data can be respectively sent to the FPGA chip 102. Accordingly, the FPGA chip 102 can apply a timestamp to the obtained sensor data, that is, write timestamp information in the obtained sensor data. Subsequently, processing such as data fusion can be performed based on the sensor data after the timestamp information is written.

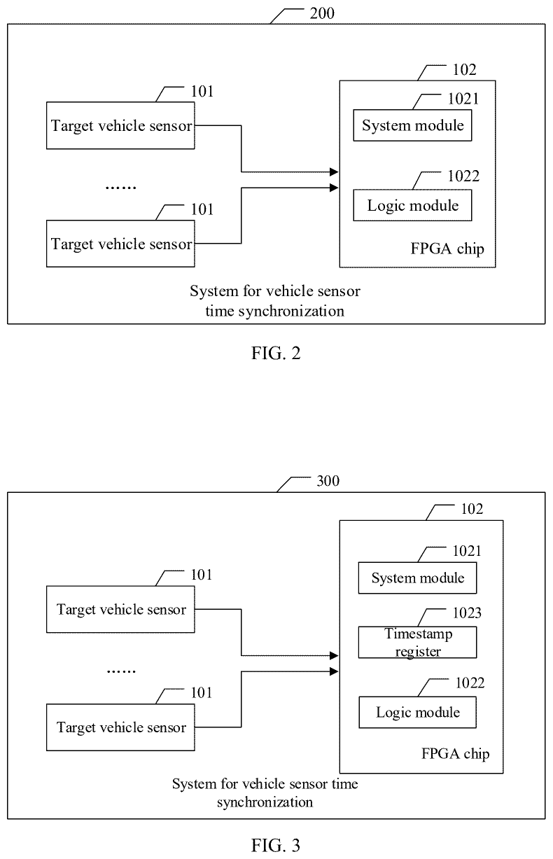

FIG. 2 is a schematic diagram of the composition structure of a second embodiment of the system 200 for vehicle sensor time synchronization of the present disclosure. As shown in FIG. 2, the system includes: target vehicle sensors 101 and a FPGA chip 102. The FPGA chip 102 further includes an FPGA system module 1021 and an FPGA logic module 1022.

The FPGA logic module 1022 is a programmable logic part in the FPGA chip 102 and can be configured as various digital logic circuits and processor peripherals, etc. The FPGA system module 1021 is a processing system part in the FPGA chip 102 and is configured to run an operating system, perform memory management, and interrupt management, etc.

In the solution described in the present disclosure, in addition to utilizing the FPGA system module 1021 and the FPGA logic module 1022 to implement original functions, the FPGA system module 1021 and the FPGA logic module 1022 can also be configured to write timestamp information.

The target vehicle sensor 101 can be divided into two groups based on a principle of load balancing. The target vehicle sensors 101 in the first group can be connected to the FPGA system module 1021, the target vehicle sensor 101 in a second group can be connected to the FPGA logic module 1022. The principle of load balancing can include: a difference between a data volume of sensor data connected to the FPGA system module 1021 and a data volume of sensor data connected to the FPGA logic module 1022 is less than a predetermined threshold. Accordingly, the FPGA system module 1021 and the FPGA logic module 1022 can respectively write the timestamp information into the obtained sensor data based on the system time of the FPGA chip 102.

The specific value of the predetermined threshold can be determined according to an actual need. In addition, how to group the target vehicle sensor 101 is not limited. For example, assuming that a total of four target vehicle sensors 101 are included, for ease of description, the target vehicle sensors are respectively referred to as a sensor “a”, a sensor “b”, a sensor “c”, and a sensor “d”. Assuming that the sensor “a” generates 45% of a total data volume, the total data volume refers to a sum of data volumes of sensor data generated by the sensor “a”, the sensor “b”, the sensor “c”, and the sensor “d”, and assuming that data volumes of the sensor data generated by the sensor “b”, the sensor “c” and the sensor “d” respectively account for 20%, 20% and 15% of the total data volume, then the sensor “a” can be grouped as one group, such as the first group, and the sensor “b”, the sensor “c” and the sensor “d” can be grouped as another group, such as the second group. Then the sensor “a” in the first group can be connected to the FPGA system module 1021, and the sensor “b”, the sensor “c”, and the sensor “d” in the second group are connected to the FPGA logic module 1022.

Through the above processing, data volumes of the sensor data obtained by the two modules can be made as close as possible, so that the two modules can process the sensor data in a load-balanced manner. This avoids significant load difference between the two modules caused by the writing of the timestamp information, and thereby improving processing efficiency and resource utilization of the two modules.

Furthermore, if necessary, the grouping manner or the modules connected to different groups can also be modified, which is very flexible and convenient. In existing multi-chip solutions, if the above modification is to be implemented, a hardware connection usually needs to be modified, which is time-consuming and costly.

FIG. 3 is a schematic diagram of the composition structure of a third embodiment of the system 300 for vehicle sensor time synchronization of the present disclosure. As shown in FIG. 3, the system includes: target vehicle sensors 101 and a FPGA chip 102. The FPGA chip 102 further includes: an FPGA system module 1021, an FPGA logic module 1022, and a timestamp register 1023.

The timestamp register 1023 can be configured to store the system time of the FPGA chip 102. Accordingly, the FPGA system module 1021 and the FPGA logic module 1022 can be configured to, for the obtained sensor data, obtain corresponding timestamp information by accessing the timestamp register 1023, and can write the obtained timestamp information into the sensor data.

In other words, the FPGA system module 1021 and the FPGA logic module 1022 can perform inter-module time synchronization through a manner of register access. Compared to an inter-chip time synchronization manner used in a multi-chip solution, the time synchronization manner described in the present disclosure can be significantly improved in terms of reliability and real-time performance.

In addition, in the multi-chip solution, considering a reason such as a time synchronization delay between chips, the timestamp information written into the sensor data can have a certain error at some times. After a single-chip solution described in the present disclosure is adopted, the above problem can be avoided, so that accuracy of the written timestamp information is improved.

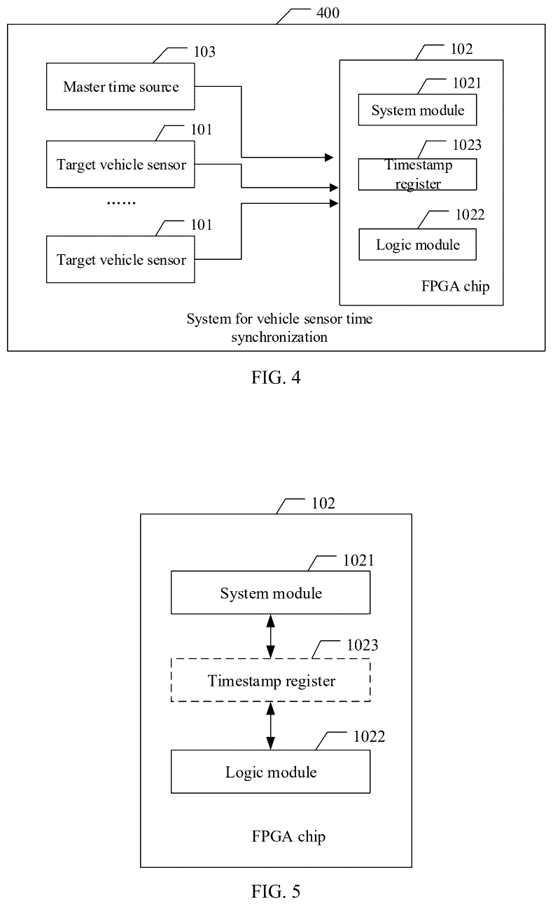

FIG. 4 is a schematic diagram of the composition structure of a fourth embodiment of the system 400 for vehicle sensor time synchronization of the present disclosure. As shown in FIG. 4, the system includes: target vehicle sensors 101, a master time source 103, and an FPGA chip 102. The FPGA chip 102 further includes: an FPGA system module 1021, an FPGA logic module 1022, and a timestamp register 1023.

The master time source can be a GPS or a gPTP device, etc.

An autonomous vehicle generally includes a GPS. The GPS is a vehicle sensor other than the target vehicle sensors 101 and has time information of the GPS. Accordingly, the system time in the timestamp register 1023 can be determined based on time information provided by the GPS. That is, the system time of the FPGA chip 102 can be obtained by parsing sensor data of the GPS. For example, when the FPGA chip 102 is powered on, the system time can be determined based on the time information of the GPS (for example, correcting an original time, etc.). If necessary, the system time can be periodically corrected based on the time information of the GPS, which is very simple and convenient, and ensures accuracy of the system time, etc. In addition, in some cases, the autonomous vehicle will also include a gPTP device, then the system time in the timestamp register 1023 can also be determined based on time information provided by the gPTP device.

In an actual application, the camera can be connected to the FPGA chip 102 through a mobile industry processor interface (MIPI) protocol. The Lidar can be connected to the FPGA chip 102 through an ethernet (eth) protocol. The IMU can be connected to the FPGA chip 102 through a serial peripheral interface (SPI) protocol. The Radar can be connected to the FPGA chip 102 through a CAN protocol. The GPS can be connected to the FPGA chip 102 through a universal asynchronous receiver/transmitter (UART) protocol.

The above is an introduction to the system embodiment. Hereinafter, a solution described in the present disclosure will be further described through an apparatus embodiment and a method embodiment, respectively.

FIG. 5 is a schematic diagram of the composition structure of the FPGA chip 102 described in the present disclosure. As shown in FIG. 5, the chip includes: an FPGA system module 1021 and an FPGA logic module 1022.

The FPGA system module 1021 and the FPGA logic module 1022 can be respectively connected to at least one of target vehicle sensors 101, which are configured to obtain collected sensor data from the connected at least one target vehicle sensor 101, and write a timestamp information into the obtained sensor data based on the system time in the FPGA chip 102. The target vehicle sensors 101 include all vehicle sensors in the target vehicle that require the timestamp information to be written.

In some embodiments of the present disclosure, the target vehicle sensors 101 can be divided into two groups based on the principle of load balancing. The target vehicle sensors 101 in the first group can be connected to the FPGA system module 1021. The target vehicle sensors 101 in the second group can be connected to the FPGA logic module 1022. The principle of load balancing can include: the difference between the data volume of the sensor data connected to the FPGA system module 1021 and the data volume of the sensor data connected to the FPGA logic module 1022 is less than a predetermined threshold.

In addition, in some embodiments of the present disclosure, the FPGA chip 102 can further include a timestamp register 1023.

The timestamp register 1023 can be configured to store the system time of the FPGA chip 102. Accordingly, the FPGA system module 1021 and the FPGA logic module 1022 can be configured to, for the obtained sensor data, obtain the corresponding timestamp information by accessing the timestamp register 1023, and write the obtained timestamp information into the sensor data.

FIG. 6 is a flowchart of an embodiment of the method for vehicle sensor time synchronization of the present disclosure. The method can be applied in an FPGA system module and an FPGA logic module. As shown in FIG. 6, the method includes the following specific implementation manners.

In step 601, it obtains sensor data collected by connected target vehicle sensors.

In step 602, it writes a timestamp information into the obtained sensor data based on a system time in the FPGA chip; The FPGA system module and the FPGA logic module are both located in the FPGA chip. The FPGA system module and the FPGA logic module are respectively connected to at least one of the target vehicle sensors. The target vehicle sensors include all vehicle sensors in a target vehicle that require a timestamp information to be written.

In some embodiments of the present disclosure, the target vehicle sensors can be divided into two groups based on the principle of load balancing. The target vehicle sensors in the first group can be connected to the FPGA system module. The target vehicle sensors in the second group can be connected to the FPGA logic module. The principle of load balancing can include: a difference between the data volume of sensor data connected to the FPGA System module and the data volume of sensor data connected to the FPGA Logic module is smaller than a predetermined threshold.

In addition, in some embodiments of the present disclosure, a manner of writing the timestamp information into the obtained sensor data based on the system time in the FPGA chip can include: for the obtained sensor data, obtaining a corresponding timestamp information by accessing a timestamp register, and writing the obtained timestamp information into the sensor data, the timestamp register being located in the FPGA chip.

It should be noted that, for the foregoing method embodiments, for the sake of simple description, the method embodiment is described as a series of action combinations, but a person skilled in the art should know that the present disclosure is not limited by a described action sequence, because according to the present disclosure, some steps can be performed in other orders or simultaneously. Secondly, those skilled in the art should also know that embodiments described in the specification are all preferred embodiments, and an involved action and an involved module are not necessarily essential to the present disclosure.

In addition, for the above various embodiments, a part not described in detail in a certain embodiment can refer to a relevant description in other embodiments.

In short, by adopting the solution described in the present disclosure, an existing multi-chip solution can be converted into a single-chip solution, thereby reducing an implementation cost, saving a system overhead, and improving processing efficiency and resource utilization rate through load balancing. In addition, the accuracy, reliability and real-time performance of written timestamp information can be improved through a register access manner inside a single chip.

The solution described in the present disclosure can be applied to an artificial intelligence field, and particularly relates to a field such as sensor, artificial intelligence chip, and autonomous driving. Artificial intelligence is a discipline that studies to make a computer to simulate some thinking processes and intelligent behaviors (such as learning, reasoning, thinking, planning, etc.) of a human, which has both a hardware level technology and a software level technology. An artificial intelligence hardware technology generally includes technologies such as sensor, dedicated artificial intelligence chip, cloud computing, distributed storage, and big data processing. An artificial intelligence software technology mainly includes several major directions such as computer vision technology, speech recognition technology, natural language processing technology, machine learning/deep learning, big data processing technology, and knowledge graph technology.

In addition, sensor data in the embodiments of the present disclosure is not for a specific user, and cannot reflect personal information of a specific user. In a technical solution of the present disclosure, processing such as collection, storage, use, processing, transmission, provision, and disclosure of involved user personal information complies with provisions of relevant laws and regulations, and does not violate public order and good customs.

According to an embodiment of the present disclosure, the present disclosure also provides an electronic device, a readable storage medium, and a computer program product.

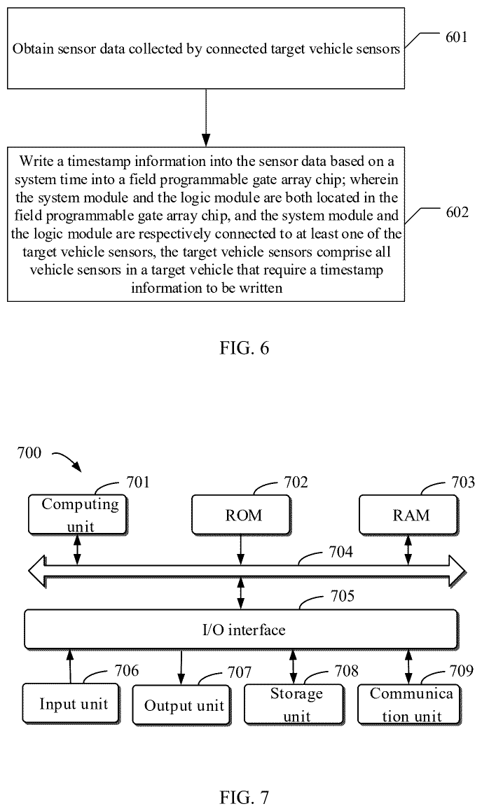

FIG. 7 shows a schematic block diagram of an electronic device 700 that can be used to implement an embodiment of the present disclosure. The electronic device is intended to represent various forms of digital computers, such as a laptop computer, a desktop computer, a workbench, a server, a blade server, a mainframe computer, and other suitable computers. The electronic device can also represent various forms of mobile apparatuses, such as a personal digital assistant, a cellular telephone, a smart phone, a wearable device, and other similar computing apparatuses. A component shown herein, a connection and a relationship thereof, and a function thereof are only used as examples, and are not intended to limit an implementation of the present disclosure described and/or claimed herein.

As shown in FIG. 7, the electronic device 700 includes a computing unit 701, which can perform various appropriate actions and processing according to a computer program stored in a read-only memory (ROM) 702 or a computer program loaded from a storage unit 708 to a random access memory (RAM) 703. In the RAM 703, various programs and data required for an operation of the electronic device 700 can also be stored. The computing unit 701, the ROM 702, and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, a mouse, etc.; an output unit 707, such as various types of displays, speakers, etc.; a storage unit 708, such as a magnetic disk, an optical disc, etc.; and a communication unit 709, such as a network card, a modem, a wireless communication transceiver, etc. The communication unit 709 allows the electronic device 700 to exchange information/data with other devices through a computer network such as an Internet and/or various telecommunication networks.

The computing unit 701 can be various general-purpose and/or dedicated processing components with a processing and computing capability. Some examples of the computing unit 701 include, but are not limited to, a central processing unit (CPU), a graphic processing unit (GPU), various dedicated artificial intelligence (AI) computing chips, various computing units that run a machine learning model algorithm, a digital signal processor (DSP), and any suitable processor, controller, microcontroller, etc. The computing unit 701 performs the various methods and processing described above, such as the method described in the present disclosure. For example, in some embodiments, the method described in the present disclosure can be implemented as a computer software program, which is tangibly contained in a machine-readable medium, such as the storage unit 708. In some embodiments, a part or all of a computer program can be loaded and/or installed onto the electronic device 700 via the ROM 702 and/or the communication unit 709. When the computer program is loaded to the RAM 703 and executed by the computing unit 701, one or more steps of the method described in the present disclosure can be performed. Alternatively, in other embodiments, the computing unit 701 can be configured to perform the method described in the present disclosure by any other suitable manner (for example, by means of firmware).

Various implementation manners of a system and a technology described herein can be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software, and/or a combination thereof. These various implementation manners can include: being implemented in one or more computer programs, the one or more computer programs being executable and/or interpretable on a programmable system including at least one programmable processor, the programmable processor being a dedicated or general-purpose programmable processor, capable of receiving data and an instruction from a storage system, at least one input apparatus, and at least one output apparatus, and transmitting the data and the instruction to the storage system, the at least one input apparatus, and the at least one output apparatus.

A program code for implementing a method of the present disclosure can be written in any combination of one or more programming languages. The program code can be provided to a processor or a controller of a general-purpose computer, a special-purpose computer, or other programmable data processing apparatus, such that the program code, when executed by the processor or the controller, causes a function/operation specified in a flowchart and/or a block diagram to be implemented. The program code can be executed entirely on a machine, partially on the machine, as a stand-alone software package partially on the machine and partially on a remote machine, or entirely on the remote machine or a server.

In the context of the present disclosure, a machine-readable medium can be a tangible medium, which can contain or store a program for use by or in combination with an instruction execution system, an apparatus, or a device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combination of the foregoing. A more specific example of a machine-readable storage medium would include an electrical connection based on one or more wires, a porta2ble computer disk, a hard disk, a random access memory, a read-only memory, an electronically programmable read-only memory (EPROM), a flash memory, an optical fiber, a portable compact disc read-only memory (CD-ROM), an optical storage device, a magnetic storage device, or any suitable combination of the foregoing.

In order to provide interaction with a user, a system and a technology described herein can be implemented on a computer, the computer having: a display apparatus (for example, a cathode ray tube (CRT) or a liquid crystal display (LCD) monitor) for displaying information to the user; and a keyboard and a pointing apparatus (for example, a mouse or a trackball), through which the user can provide an input to the computer. Other kinds of apparatuses can also be used to provide interaction with the user; for example, feedback provided to the user m3ay be any form of sensory feedback (for example, visual feedback, auditory feedback, or tactile feedback); and an input from the user can be received in any form (including a sound input, a voice input, or a tactile input).

A system and a technology described herein can be implemented in a computing system (for example, as a data server) including a back-end component, or a computing system (for example, an application server) including a middleware component, or a computing 4system (for example, a user computer having a graphical user interface or a web browser, through which a user can interact with an implementation manner of the system and the technology described herein) including a front-end component, or a computing system including any combination of such back-end component, middleware component, or front-end component. Components of the system can be interconnected by any form or medium of digital data communication (e.g., a communication network). Examples of a communication network include: a local area network (LAN), a wide area network (WAN), and an Internet.

The computer system can include a client and a server. The client and the server are generally far away from each other and usually interact through a communication network. A relationship between the client and the server is generated by a computer program running on a corresponding computer and having a client-server relationship with each other. The server can be 5a cloud server, a server of a distributed system, or a server combined with a blockchain.

It should be understood that various forms of flows shown above can be used to reorder, add, or delete steps. For example, each step described in the present disclosure can be performed in parallel, sequentially, or in a different order, as long as a desired result of a technical solution disclosed in the present disclosure can be achieved, which is not limited herein.

The above specific implementation manners do not constitute a limitation on the protection scope of the present disclosure. A person skilled in the art should understand that various modifications, combinations, sub-combinations, and substitutions can be made according to a design requirement and other factors. Any modification, equivalent replacement, and improvement made within the spirit and principle of the present disclosure shall be included in the protection scope of the present disclosure.

What is claimed is:

1. A system for vehicle sensor time synchronization, comprising:
target vehicle sensors and a field programmable gate array chip, the target vehicle sensors comprise all vehicle sensors in a target vehicle that require a timestamp information to be written;
the target vehicle sensors are connected to the field programmable gate array chip, and are configured to send collected sensor data to the field programmable gate array chip;
the field programmable gate array chip is configured to write the timestamp information into the sensor data based on a system time of the field programmable gate array chip;
wherein the field programmable gate array chip comprises: a system module and a logic module;
the system module and the logic module are respectively connected to at least one of the target vehicle sensors based on a principle of load balancing, and are respectively configured to write the timestamp information into obtained sensor data based on the system time.

2. The system for vehicle sensor time synchronization according to claim 1, wherein,
the target vehicle sensor is divided into two groups based on the principle of load balancing, target vehicle sensors in a first group are connected to the system module, and target vehicle sensors in a second group are connected to the logic module.

3. The system for vehicle sensor time synchronization according to claim 1, wherein,
the field programmable gate array chip further comprises: a timestamp register;
the timestamp register is configured to store the system time;
the system module and the logic module are configured to, for the obtained sensor data, obtain corresponding timestamp information by accessing the timestamp register, and write the timestamp information into the sensor data.

4. The system for vehicle sensor time synchronization according to claim 1, further comprising:
a master time source, wherein the system time is determined based on a time information provided by the master time source.

5. The system for vehicle sensor time synchronization according to claim 4, wherein,
the master time source comprises: a global positioning system, or a generalized precision time protocol device.

6. The system for vehicle sensor time synchronization according to claim 2, further comprising:
a master time source, wherein the system time is determined based on a time information provided by the master time source.

7. The system for vehicle sensor time synchronization according to claim 3, further comprising:
a master time source, wherein the system time is determined based on a time information provided by the master time source.

8. A field programmable gate array chip, comprising: a system module and a logic module;
the system module and the logic module are respectively connected to at least one of target vehicle sensors based on a principle of load balancing, and are configured to obtain sensor data collected by the connected target vehicle sensors, and write a timestamp information into the sensor data based on a system time in the field programmable gate array chip, wherein the target vehicle sensors comprise all vehicle sensors in a target vehicle that require a timestamp information to be written.

9. The field programmable gate array chip according to claim 8, wherein,
the target vehicle sensor is divided into two groups based on a principle of load balancing, target vehicle sensors in a first group are connected to the system module, and target vehicle sensors in a second group are connected to the logic module.

10. The field programmable gate array chip according to claim 8, further comprising:
a timestamp register, configured to store the system time;
the system module and the logic module are configured to, for the obtained sensor data, obtain corresponding timestamp information by accessing the timestamp register, and write the timestamp information in the sensor data.

11. The field programmable gate array chip according to claim 9, further comprising:
a timestamp register, configured to store the system time;
the system module and the logic module are configured to, for the obtained sensor data, obtain corresponding timestamp information by accessing the timestamp register, and write the timestamp information in the sensor data.

12. A method for vehicle sensor time synchronization, wherein the method is applied in a system module and a logic module, the method comprising:
obtaining sensor data collected by connected target vehicle sensors;
writing a timestamp information into the sensor data based on a system time into a field programmable gate array chip;
wherein the system module and the logic module are both located in the field programmable gate array chip, and the system module and the logic module are respectively connected to at least one of the target vehicle sensors based on a principle of load balancing, the target vehicle sensors comprise all vehicle sensors in a target vehicle that require a timestamp information to be written.

13. The method for vehicle sensor time synchronization according to claim 12, wherein,
the target vehicle sensors are divided into two groups based on the principle of load balancing, target vehicle sensors in a first group are connected to the system module, and target vehicle sensors in a second group are connected to the logic module.

14. The method for vehicle sensor time synchronization according to claim 12, wherein,
writing the timestamp information into the sensor data based on the system time into the field programmable gate array chip comprises:
for the obtained sensor data, obtaining corresponding timestamp information by accessing a timestamp register, and writing the timestamp information into the sensor data, wherein the timestamp register is located in the field programmable gate array chip.

15. A non-transitory computer readable storage medium with computer instructions stored thereon, wherein the computer instructions are used for causing a method for vehicle sensor time synchronization, wherein the method for vehicle sensor time synchronization comprises:
obtaining sensor data collected by connected target vehicle sensors;
writing a timestamp information into the sensor data based on a system time into a field programmable gate array chip;
wherein the system module and the logic module are both located in the field programmable gate array chip, and the system module and the logic module are respectively connected to at least one of the target vehicle sensors based on a principle of load balancing, the target vehicle sensors comprise all vehicle sensors in a target vehicle that require a timestamp information to be written.

16. The non-transitory computer readable storage medium according to claim 15, wherein,
the target vehicle sensors are divided into two groups based on the principle of load balancing, target vehicle sensors in a first group are connected to the system module, and target vehicle sensors in a second group are connected to the logic module.

17. The non-transitory computer readable storage medium according to claim 15, wherein,
writing the timestamp information into the sensor data based on the system time into the field programmable gate array chip comprises:
for the obtained sensor data, obtaining corresponding timestamp information by accessing a timestamp register, and writing the timestamp information into the sensor data, wherein the timestamp register is located in the field programmable gate array chip.
